(19) United States
(12) Patent Application Publication
(10) Pub. No.: US 2008/0005226 A1
(43) Pub. Date: Jan. 3, 2008

(54) A method and system for one-to-one communication through proxy

(76) Inventor: Srinivasan Subbian, Bethesda, MD (US)

Correspondence Address: MAXVALUEIP CONSULTING, 11204 ALBERMYRTLE ROAD, POTOMAC, MD, 20854, US

(21) Appl. No.: 11/461,398

(22) Filed: Jul. 31, 2006

Related U.S. Application Data
(63) Continuation-in-part of application No. 11/478,635, filed on Jul. 3, 2006.

(51) Int. Cl. G06F 15/16

(52) U.S. Cl. 709/203; 709/202

(57) ABSTRACT

A method and system for one-to-one communication through proxy. Also, it relates to a method and system for communicating to the networks using mobile phones. In one example, this can be done without computer-based online user registration. The client system uses a text capable mobile phone to post a message through Short Message Service (SMS), and the message is received by the server system. The server system receives the message, along with the originating mobile phone number from the client system. The server system assigns a unique identifier to this message, and associates it to the mobile phone number of the client system. The message is translated by the server system into formats that can be accessed by other client systems, such as mobile, computers, and Personal Digital Assisstants. This message can be read and responded to by client systems (using mobile or computers) without revealing the SMS caller ID (identification).

### RELATED APPLICATIONS

The present invention relates to the following co-pending applications, with the same assignee and inventors:

“A method and system for dynamic list prioritization”, filed on the same day as current application, docket number OHHO-00004.

CIP of application Ser. No. 11/478,635, filed Jul. 3, 2006, “Method and system for communicating to networks using mobile phones”.

### BACKGROUND OF THE INVENTION

The present invention relates to a method and system for one-to-one communication through proxy.

With the tremendous growth of the mobile devices, content providers on the Internet have started offering content to mobile devices, such as pocket PCs (Personal Computer), mobile phones, and PDAs (Personal Digital Assisstant), using XML (Extensible Markup Language), WML (Wireless Markup Language), XHTML (Extensible HyperText Markup Language), XHTML MP (Extensible HyperText Markup Language, Mobile Profile), and other formats, using wireless communications.

Wireless hand-held devices is primarily used for voice and data communications. However, it can be used for any content, such as video, text, music, pictures, etc. One type of wireless data communication is Short Message Service (SMS), which is a service available on most digital mobile phones (and other mobile devices, e.g. Pocket PC, or occasionally, even desktop computers), that permits sending short messages between mobile phones, other handheld devices, and even landline telephones. Other uses of text-messaging are for ordering ringtones or wallpapers and entering competitions. There are also many online services available on the Internet that allow users to send text messages using a computer.

SMS was initially developed as a part of GSM standard (Global Systems for Mobile Communications), but it is now available on a wide range of mobile networks, such as GSM/CDMA (Code Division Multiple Access)/TDMA (Time Division Multiple Access)/GPRS (General Packet Radio Service)/EDGE (Enhanced Data for GSM Environment) networks, including 3G (Third Generation) networks.

Messages are sent via a store-and-forward mechanism to a Short Message Service Centre (SMSC), which is a part of a GSM network, which will attempt to send the message to the recipient, and possibly retry, if the user is not reachable at a given moment. Both Mobile Terminated (MT) and Mobile Originating (MO) operations are supported. Message delivery is a best-effort procedure. So, there are no guarantees that a message will actually be delivered to its recipient. The payload length is limited to 140 characters.

There are SMS gateways available that connect the mobile network with TCP/IP (Tansmission Control Protocol/Internet Protocol)-based networks, using protocols like SMPP (Short Message Peer-to-Peer) or UCP/EMI (Universal Computer Protocol/Exchange Message Interface). These gateways can be configured to make an HTTP (HyperText Transfer Protocol) request, to call a script running on the webserver when an SMS message is received. The script can query a DB (database) and reply back directly with a text message to the device that made the query. Or, the script can initiate a new HTTP request to take some new action.

Today's SMS technology is primarily used to send text messages to others, mobile-marketing (polling with 2-way messaging), mobile-surveys, alerts, reminders, or system integration, pulling content based on keywords in SMS for enterprises, content providers, and carriers.

Examples of prior art are:

1. SMS Gateway: two-way SMS: http://nowsms.com, which requires registration.

2. http://mozat.com, which requires full registration on-line, and it involves pre-defined questions.

3. Yahoo mobile, Google mobile, and http://sms.ac, which are different from the current invention.

4. U.S. Pat. No. 6,424,841 (SMS with improved utilization of available bandwidth, by Gustafsson), U.S. Pat. No. 7,023,989 (Arrangement of delivering applications to a network enabled telephony device, by Turner et al.), U.S. Pat. No. 7,020,685 (Method and apparatus for providing Internet content to SMS-based wireless devices, by Chen et al.), U.S. Pat. No. 6,321,257 (Accessing Internet service in a mobile communication network, by Kotola et al.), U.S. Pat. No. 6,961,330 (Web development and deployment, by Cattan et al.), U.S. Pat. No. 6,965,935 (Network architect for Internet appliances, by Diong), and U.S. Pat. No. 6,658,260 (Inter-carrier short messaging service, by Knotts) fail to teach the current invention.

5. http://19secret.com: It requires computer registration, and it is not a two-way communication.

6. U.S. Pat. No. 6,938,021 (Shear et al.), U.S. Pat. No. 6,928,425 (Grefenstette of Xerox), U.S. Pat. No. 6,842,433 (West et al.), U.S. Pat. No. 6,820,075 (Shanahan et al. of Xerox), U.S. Pat. No. 6,778,979 (Grefenstette et al.), U.S. Pat. No. 6,769,009 (Reisman), U.S. Pat. No. 6,732,090 (Shanahan et al.), U.S. Pat. No. 6,658,464 (Reisman), U.S. Pat. No. 6,611,682 (Reisman), U.S. Pat. No. 6,594,692 (Reisman), and U.S. Pat. No. 6,557,054 (Reisman) also fail to teach the current invention.

7. http://thesmszone.com: It requires computer registration, and it is not a two-way communication.

8. http://www.blonnet.com/2006/04/19/stories/2006041903301200.htm (about voice-based SMS) is also different from the current invention.

9. http://www.its4sms.com/sms solutions asp (customized SMS solutions) is also different from the current invention.

10. http://winksite.com uses WAP (Wireless Application Protocol), and it is different from the current invention.

11. As to one-to-one communication through proxy, Saulpaugh et al. (U.S. Pat. No. 7,072,967, titled “Efficient Construction of message endpoints”, issued Jul. 4, 2006) fails to teach the current invention.

12. As to Content Processing Engine, Kolls (U.S. Pat. No. 7,003,289, issued Feb. 21, 2006, titled “communication interface device for managing wireless data transmission between a vehicle and the Internet”) fails to teach the current invention.

13—As to Dynamic List Priority, Google, Inc. patents by Kamvar et al. (U.S. Pat. No. 7,028,029, issued Apr. 11, 2006, “Adaptive computation of ranking”) and by Patel et al. (U.S. Pat. No. 6,839,702, issued Jan. 4, 2005, “System and method for highlighting search results”) both fail to teach the current invention.

### SUMMARY OF THE INVENTION

One of the embodiments of this invention relates to a method and system for one-to-one communication through proxy. It also relates to a method and system for posting messages from a first client system to a server system, and receiving responses from other client systems through the server system, without the client system's (responsible for originating messages and responding clients systems) caller-ID being displayed. This system does not require the user to perform any registration process, either using a mobile phone or a computer system.

The communication can be done one-to-many (either mobile-to-mobile or mobile-to-computer), or one-to-one communication through proxy (mobile-to-mobile). Content Processing Engine (CPE) is the brain behind the server system, which controls the messaging flow and ordering, in addition to performing the administrative tasks. Dynamic List Priority is a method of ranking and ordering the messages based on different metrics.

### BRIEF DESCRIPTION OF THE DRAWINGS

FIG. 1. Block diagram illustrating one of the embodiments of the invention (one-to-many).

FIG. 2. Relationship table of one embodiment.

FIG. 3. Flow diagram of a routine for posting the content.

FIG. 4. Block diagram illustrating an embodiment for responding to a posted content.

FIG. 5. Flow diagram of a routine for editing a posted content.

FIG. 6. Block diagram illustrating a method to edit, get, pause, or delete content (one-to-many).

FIG. 7. Flow diagram of a routine for replying to a posted content.

FIG. 8. Block diagram illustrating an embodiment of the present invention with the responding client system (as a computer), which is verified by the server system for the validity of the device number entered using a web interface.

FIG. 9. Block diagram illustrating an embodiment of the present invention for the mobile-to-mobile proxy communication (one-to-one).

FIG. 10. Flow diagram illustrating an embodiment of the present invention for one-to-one communication, using mobile-to-mobile.

FIG. 11. Flow diagram illustrating an embodiment of the present invention for one-to-many communication, using mobile-to-mobile.

FIG. 12. Relationship diagram for one-to-many, wherein the content is posted on the web, with replies coming back.

FIG. 13. Flow chart for one of the embodiments of the invention, described further in section below, related to one-to-one communication through proxy.

FIG. 14. Generalization of teaching above, for distributed system (see FIG. 9).

FIG. 15. Generalization of teaching above, for distributed system (see FIG. 10).

### DETAILED DESCRIPTION OF THE PREFERRED EMBODIMENTS

The present invention describes a method and system for communicating between mobile systems through a proxy server system that hides the originating and responding client systems' device IDs (identification).

The client system is any text-message-capable digital mobile phone that is subscribed to the SMS service with a service provider. The server system comprises of a gateway with a GSM modem and a SIM card, content processing engine, database, and a server engine that can render the contents stored in formats such as HTML, WML, XHTML, XHTML MP, XML, and CHTML.

A client system posts a message via SMS to a 10 digit number, or to a Common Short Code (CSC), which is typically an easy to remember 4 or 5-digit number. This message is received by the gateway in the server system. The message is validated by the Content Processing Engine (CPE). The CPE assigns a message priority to this message (based on the metrics, such as keywords, age of the content, location, number of characters contained in the content), and post it on the web in the formats such as WML/XHTML/HTML/XHTML MP.

The message priority is used to rank various messages, and the message with the highest priority is listed at the top of the page, followed by other messages in descending order, based on priority.

This method and system enables the client system (users to use the service with only an SMS-capable mobile phone) to post messages, and receive responses to the posted messages, through the server system, using the text message service, without revealing the device ID of the client system, until a point when one of the client systems determines enough trust is established through exchanges of these private messages that they can include the device ID in a message, which is forwarded to the receiver, so they can communicate directly, bypassing the server system.

This invention enables the client systems to communicate with each other without any registration or sign-on process. No computer is necessary, as a part of the client system, to engage in private communications.

There is a need for a system and method that can enable SMS-capable digital phones to communicate with each other, using a proxy system for sending and receiving text messages, with the caller-ID masked.

This method also enables a client system, such as a text-capable mobile phone, capable to communicate with the users on the Internet without having access to a computer, by following few simple steps, to enable communication and conduct commerce, by only using their mobile phones.

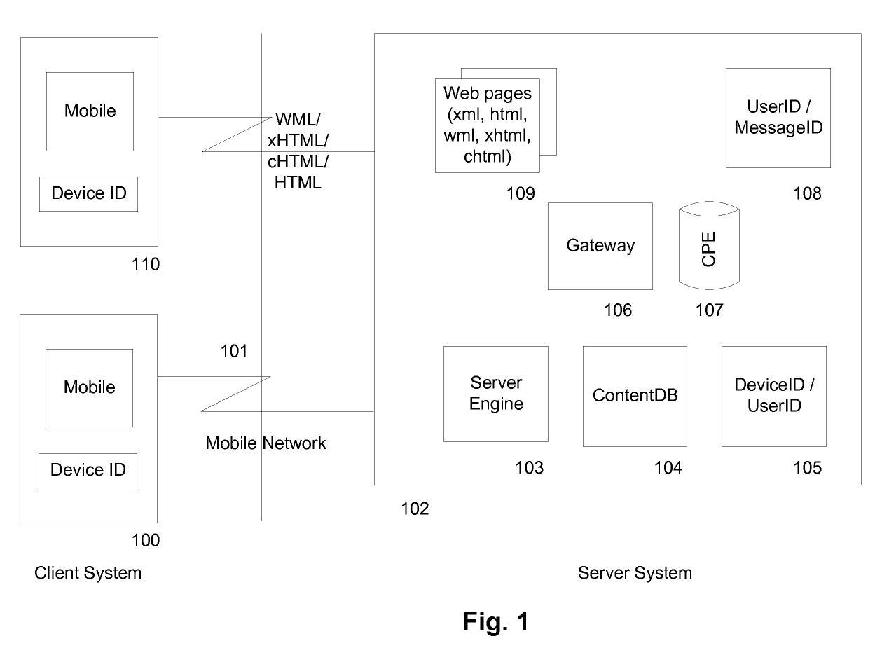

FIG. 1 is a block diagram illustrating an embodiment of the present invention. This embodiment supports any text-capable mobile phone (100 and 110) to communicate with each other anonymously, using the server system 102. The server system 102 comprises of a server engine 103, a content database 104, a device identifier/user ID table 105, a gateway 106, a content processing engine 107, a user identifier/message ID table 108, and various device accessible pages 109.

The client system 100 posts a message using SMS to a 10-digit number, or to a Common Short Code (CSC), which is received by the gateway 106. The gateway 106 has a SIM card in a GSM modem. The message is then processed by the content processing engine 107, and stored in a content database 104, with the device ID/user ID mapped to a table 106, along with another mapping table for the user ID/message ID 108. The content is then rendered in various formats 109, such as XML, HTML, WML, XHTML, XHTML MP, or CHTML, which can be viewed by the client system 110 using WAP or HTTP protocol.

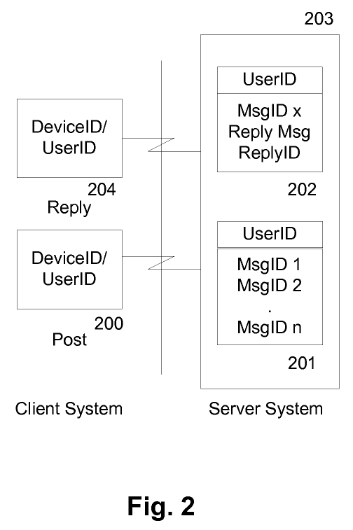

FIG. 2. illustrates the relationship table in the server system 203. When a client system 200 posts a message through SMS, the server system 203 receives the message and assigns a unique message ID. All subsequent new messages from the same device ID will be mapped into a table with the same user-ID. The user-ID or identification name can be any sequence of letters, characters, numbers, symbols, and names.

The identity of the user refers to caller-ID, e-mail address, street address, name, any future location-base services, social security number, or similar indices, numbers, and specific characteristics.

A single client system 200 can post many messages, and each of those messages are assigned a unique message ID, and is stored in the user ID/message ID table 201. This posted message is converted into various formats, by the server system 203, that is accessible by other client system 204 through WML, HTML, XHTML MP, and CHTML (depending on the client system's 204 capability, this message can be read using WAP or HTTP).

When the client system 204 replies to a message posted by client system 200, the server system 203 assigns a unique user ID to the device ID of the client system, looks at the message ID to perform a table lookup of the device ID, and the message is sent to the client system 200 with a reply ID 202. The client system 204 can reply to many messages posted by other client systems, and each of those replies are assigned a unique reply ID, and is stored in the table 202.

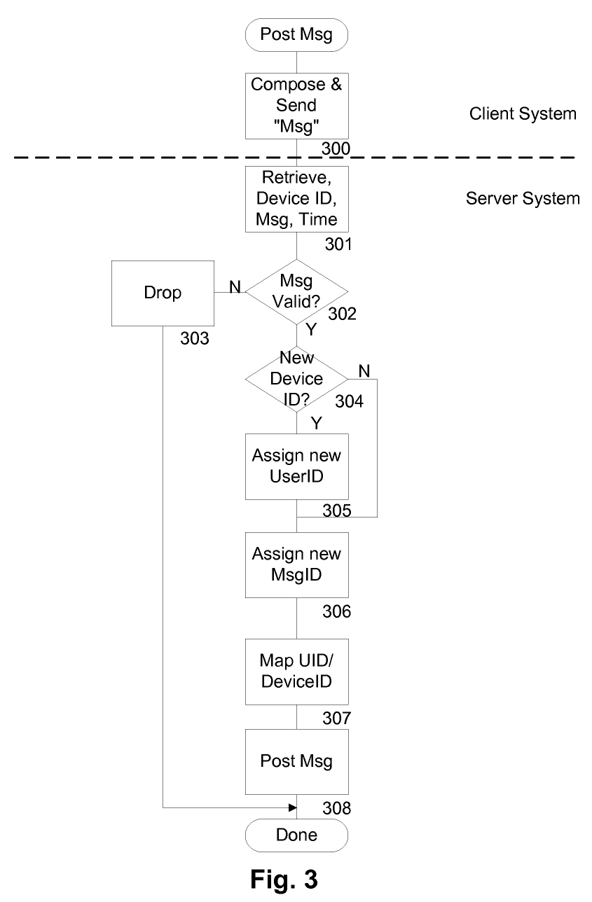

FIG. 3. illustrates a flow diagram of a routine for posting the message. A client system in step 300 composes a message and sends it to a 10-digit number of the SIM contained in the GSM modem of the gateway 301. When the message is received, the server system retrieves the message, the device ID of the client system, and the time the message was received. This information is sent to the content processing engine 302, which checks the validity of the received message based on various metrics, such as keywords, location, age of the message, etc. If the number of messages received by the server system from the same device ID within a specific period of time exceeds a set threshold the message is dropped.

If the received message does not pass the content verification check, the received content is dropped from further processing 303. If the message passes the content validation check, further processing is performed. If the incoming message device ID is new, a unique new user ID is assigned to this device ID. If this device ID has already posted a message, step 305 is skipped and a new message ID is assigned 306. The user ID is mapped to the device ID 307, and the message is posted into the database 308, which is then converted into various formats, such as XML, WML, HTML, XHTML, CHTML, etc.

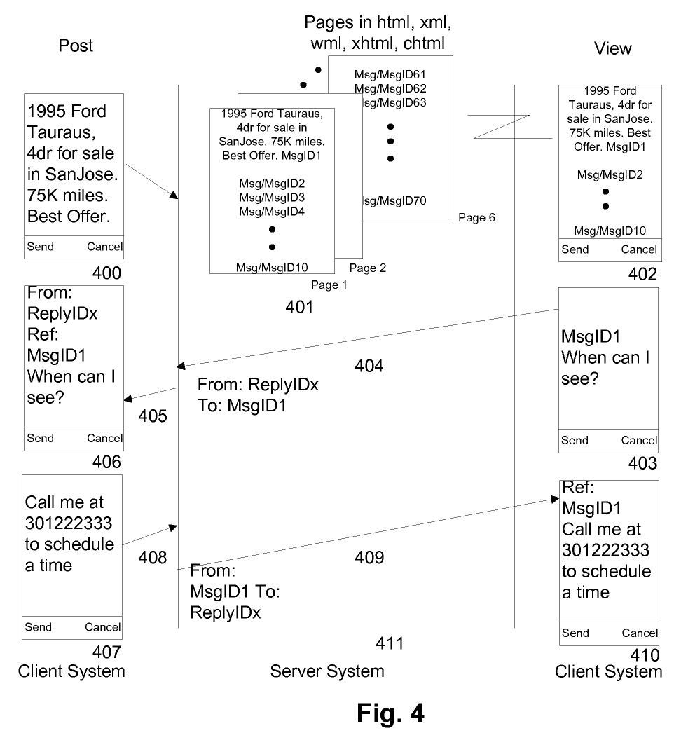

FIG. 4. is a block diagram illustrating an embodiment for responding to a posted content. This block diagram provides an example of a client system posting a message, which is responded to by another client system. This is an example of one-to-many format.

A client system 400 composes and posts a message to the server system 411. The server system 411, after performing the content validation checks, through the content processing engine, posts the content into a database, which is rendered in various formats, such as HTML, XHTML, WML, XML, CHTML, etc. This example shows 10 messages per page, and there can be many pages based on the number of messages posted. The variations of the presentation of messages in different formats and styles are intended to be protected under current invention. The posted content does show only the message and the message ID.

Client system 402 views the messages by going through the URL of the website using HTML, WML, WML, CHTML, etc., and replies to the message ID 1 through the server system 411. The server system 411 receives the reply message 404 from the client system 403, along with the message ID 1, and assigns a unique reply ID, which is then delivered 405 to client system 406, which posted the original message.

Client system 407 replies back 408 to the message received from client system 403 through the server system 411. The server system 411 looks at the reply ID, and sends the message 409 to the client system 410. During this communication between the client systems, through the server system 411, the communication remains private, and when one of the parties decides a trust is established through their private messages, one of them can send the direct phone number or email, to be contacted directly, bypassing the server system 411 for further direct communication.

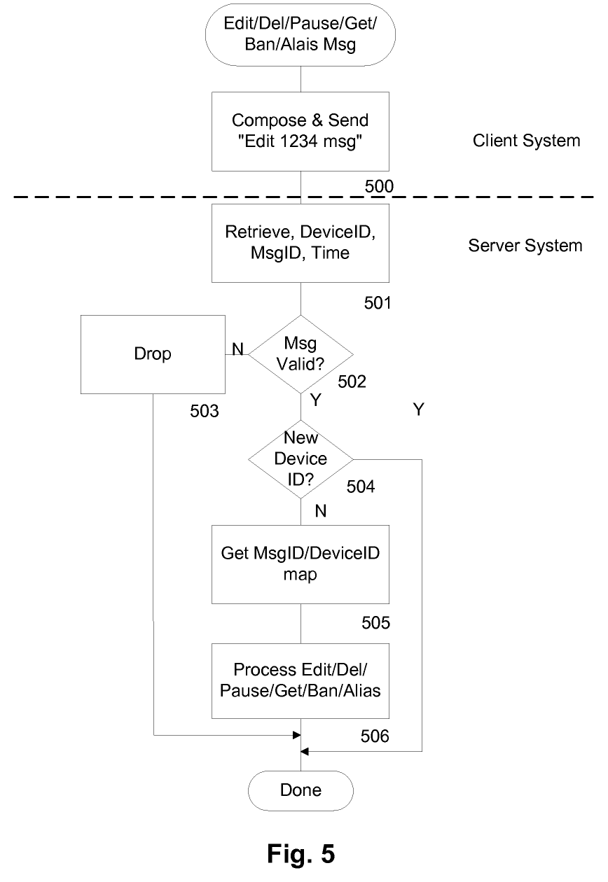

FIG. 5. illustrates a flow diagram of a routine for editing a posted content by a client system, which posted the original message. A client system wishing to edit a message posted previously composes and sends a text message with edit msgID 500 to the 10-digit phone ID, or CSC of the SIM in the GSM modem. This message is received by the server system along with the device ID, new message, msg ID that needs to be edited, and the time stamp 501.

A content validation check is performed by the content processing engine 502 and, if the content validity check fails, the request is dropped 503. Further processing is done, if the content validity check is passed. In step 504, the server system checks to see if the incoming message is from a new device ID 504, by checking the database. If it is a new device, the client systems request is dropped, as a message could not have been posted without the server system logging in the device ID.

If it is not a new device, it is highly likely that the message could have been posted by this client system, and further check is done to process the request. In step 505, the server system checks the device ID and message ID table, and if there is a match, the request for edit is processed 506 by overwriting the old message in the content database.

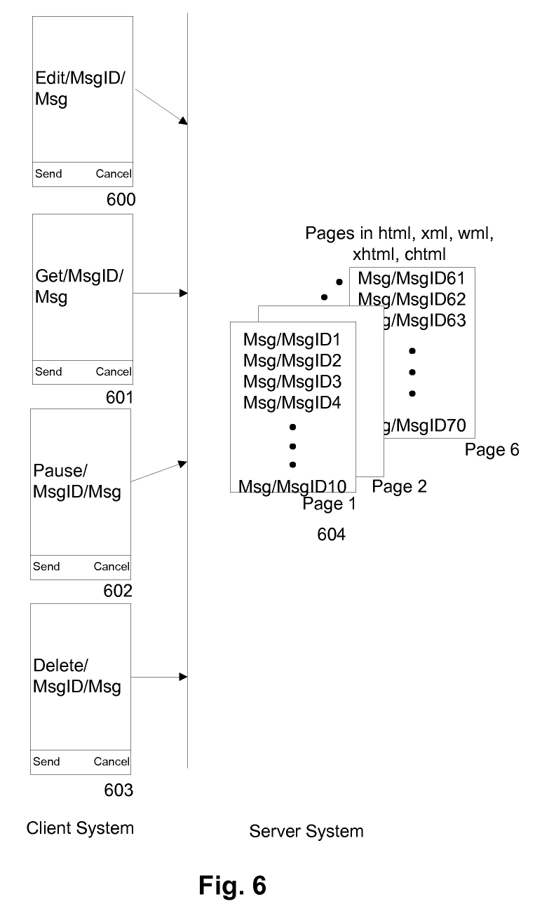

FIG. 6. is a block diagram illustrating the method to edit, get, pause, or delete content (one-to-many). To edit a message, a client system sends a message with “edit msgID” to the server system, which does validity checks through the content processing engine in the server system, and process the request.

The same process is followed for deleting a message: The incoming text message is checked for “del msgID” by the server system 604. There maybe instances that when a client system might have posted multiple messages and could have forgotten all the message IDs: In this case, the command used will be “get” and the system replies back, via text message, with all the message ID's corresponding to the client systems device ID.

In a peer-to-peer communication between two mobile systems, there may be instances when one client system would not want to receive any messages from a certain client system. In this scenario, the client system can send a message to the server system with “ban userID”, or send a “pause x userID”, where x is the hold-down timer, in minutes, when during that time frame, any messages sent will be dropped.

The server system assigns a unique userID for all new client systems. The client system has options to add a unique alias that can be easily remembered by others, by sending the following text message to the server system “alias fancyname”, and if that specific alias is available, it will be assigned. Otherwise, the server system will send out a text message requesting the user to make another choice.

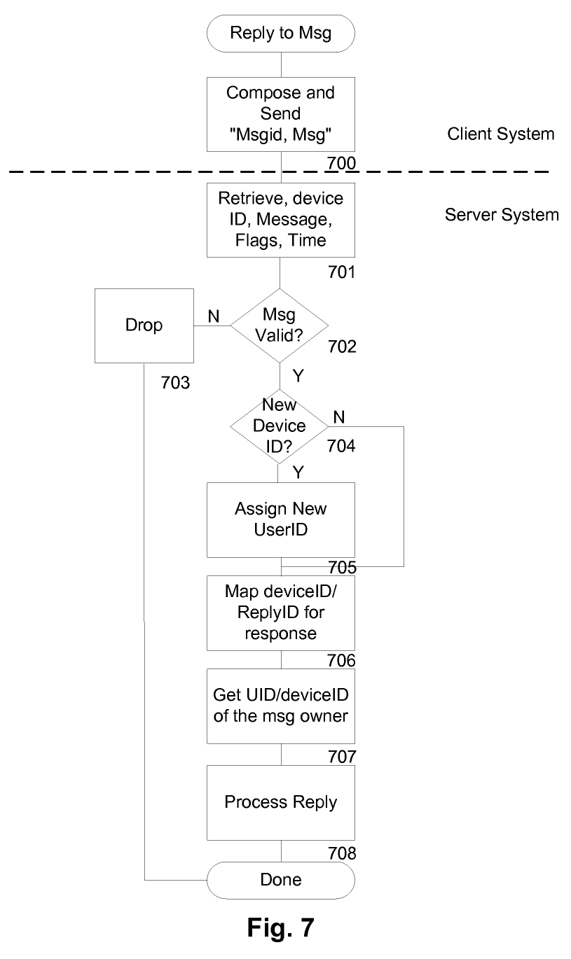

FIG. 7. illustrates a flow diagram of a routine for replying to a content posted by a client system. A client system posts a message to a server system which is accessible to other client systems via HTML, XHTML, XHTML MP, XML, WML, or CHTML. A client system responds to one of those messages with a message ID and a message 700. The server system receives the message 701 along with the device ID, flags, and time. The flags have privacy on/off keyword, which when enabled or disabled, will show the device ID in a communication between client systems through the server system. The content processing engine 702 checks the validity of the message: if it passes, further processing is done. Otherwise, it is dropped 703. Step 704 is done, if the content passes the validity check and the server system checks to see if the device ID is new. If it is new, a unique user ID is assigned 705. If the incoming messages device is already in the system, step 705 is skipped. The server system maps the reply ID to the device ID 706, looks at the msg ID, and gets the user ID from the device ID/user ID table 707, and sends the message 708 to the client system that posted the message.

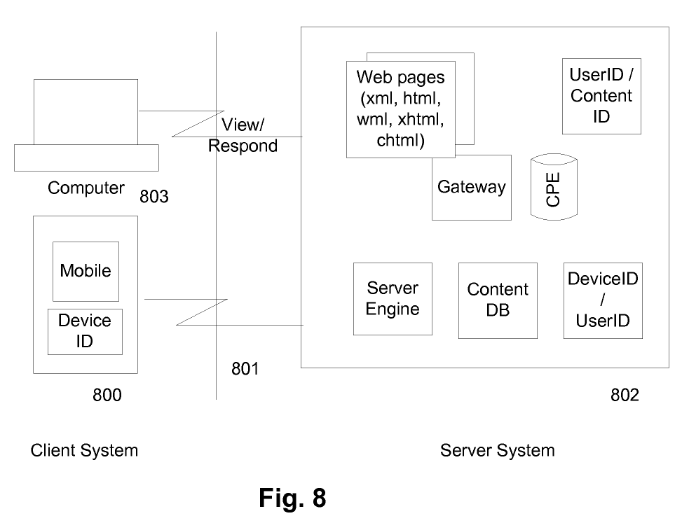

FIG. 8. is a block diagram illustrating an embodiment of the present invention with the client system responding from a computer, but with subsequent communication happening through a mobile phone. This method helps a client system with a computer and a mobile phone to interact with a client system, with only a mobile phone.

A client system 800 posts a text message 801 to the server system 802. The server system 802 posts the message into the content base after validity checks, and it is rendered in various formats such as XML, WML, XHTML, XHTML MP, HTML, CHTML, etc.

Another client system 803 accesses the message via HTTP through the website, and clicks on the message ID corresponding to the message from the web page. The client system 803 is presented with a form which has two fields: a field to enter a mobile number, and the second field for message. After the client system fills out this form and clicks the send button, the server system sends a text message back to the client system's 803 mobile phone to reply back to the Server System 802 with an ACK (Acknowledgement). This helps the server system 802 to verify the mobile number entered by the client system 803 is correct. Once the ACK is received by the server system 802, the message is then sent to the client system 800.

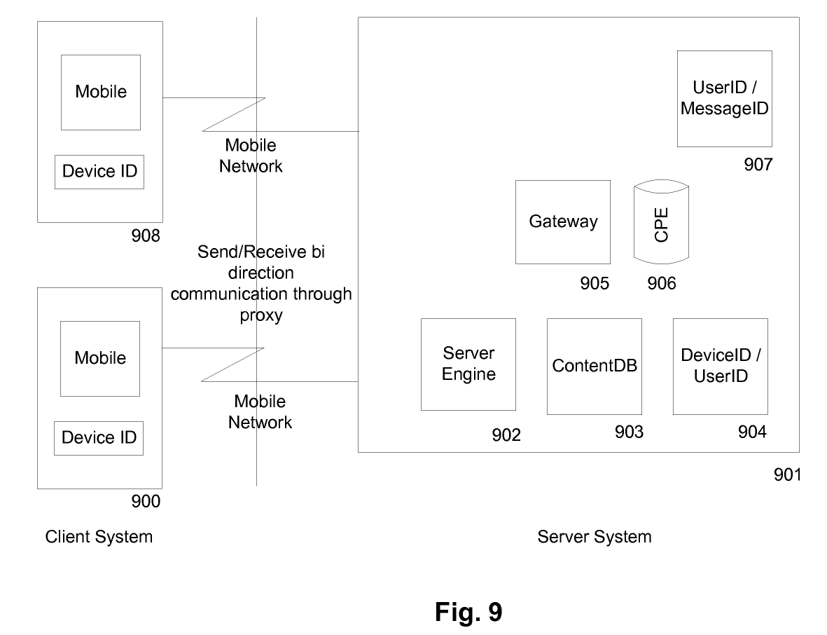

FIG. 9. is a block diagram illustrating an embodiment of the present invention for mobile-to-mobile proxy communication (one-to-one). This embodiment supports direct bi-directional peer-to-peer communication between mobile phones, through the server system, by obfuscating the mobile ID of the client systems. The server system 901 comprises of a server engine 902, content DB (database) 903, a table for device ID/user ID mapping 904, a table for user ID/message ID mapping 907, a gateway 905, and a content processing engine 906.

Client system 900 sends a text message to client system 908 through the server system 901 using the client system 908 phone ID or its user ID. The server engine maps the device ID of the client systems 900 with a unique user ID, and sends the message to client system 908. Client system 908 replies back to the message, with optional privacy flag enabled or disabled, through the server system. The server system looks at the user ID/device ID table, and sends the message to client system 900. If the privacy option is enabled the reply will have the user ID of the client system 908. Otherwise, the device ID of the client system 908 will be shown to client system 900.

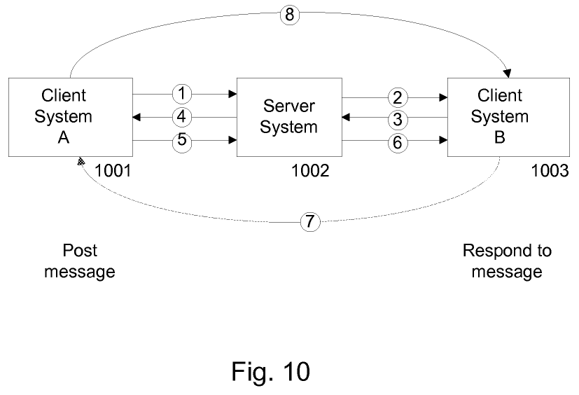

FIG. 10. is a flow diagram illustrating an embodiment of the present invention for one-to-one communication using mobile-to-mobile client systems. Client system A 1001 sends a text message to client system B 1003 through the server system 1002, either by using client system 1003 user ID, alias, or its device ID.

In 1, the server system 1002 receives the message along with the device ID, message, time message received, flag options for privacy on or off, and the user ID (or device ID) of client system 1003. After passing the validity check through the content processing engine, in the server system, the message is sent to (2) the client system B 1003. If privacy flag is enabled as requested by client system A 1001, client system B 1003 will receive the message with Client system A's 1001 user ID, or alias, if it had been setup.

Client system B 1003 replies (3) to A with a message with privacy on, through the server system 1002. The server system 1002 delivers the reply message back (4) to Client system A 1001, with the user ID, or an alias, if it had been setup.

Client system A 1001 replies back to the reply (5) with privacy off, through the server system 1002, to Client System B 1003. The server system 1002 delivers the message (6) this time to client system B 1003, with client system A's 1001 message and the phone ID, as the message was sent with privacy off.

Now that the Client system B 1003 knows the Client system A's phone number, communication can be done directly, bypassing the server system.

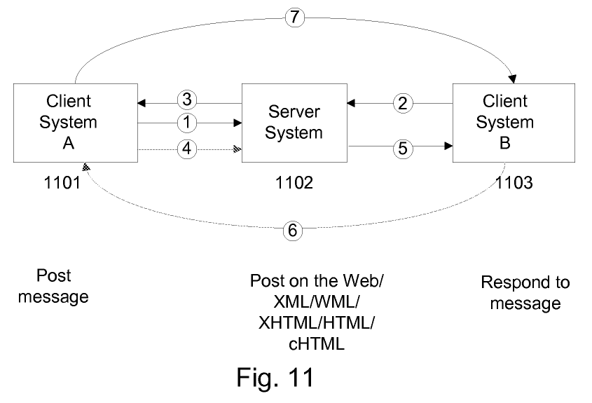

FIG. 11. is a flow diagram illustrating an embodiment of the present invention for one-to-many communications, using mobile-to-mobile.

Client system A 1101 posts a message to the server system 1002, by using a 10-digit phone number, or a Common Short Code (CSC).

In 1, the server system 1102 receives the message, along with the device ID, message, time, flag options for privacy on or off, from Client System A 1101. After passing the validity check, through the content processing engine in the server system 1102, the message is posted to the content database, which is then rendered into pages in different formats, such as XML, WML, HTML, XHTML, MP, CHTML, etc. Client system B 1103 responds to the message (2) with privacy on option (usually default), back to the server system, via a text message. The server system checks the content validity, performs a message ID look up, to get the device ID, and sends this reply (3) to Client system A 1101, with Client system B's 1103 user ID, or alias, if it had been setup. An example of the content validity is checking for the bad words in the text, which will result in either deletion of the message, or a very low priority score, so that the message priority is very low, and either the message does not show up, or gets deleted fast.

One can choose in the privacy option to send user ID, alias, or device ID.

Client System A 1101 replies back to Client System B 1103 through the server system 1102 with privacy off, with a message that includes A's phone number (4), which the server system delivers to B 1103 (5). B calls A through the phone number, without going through the server system.

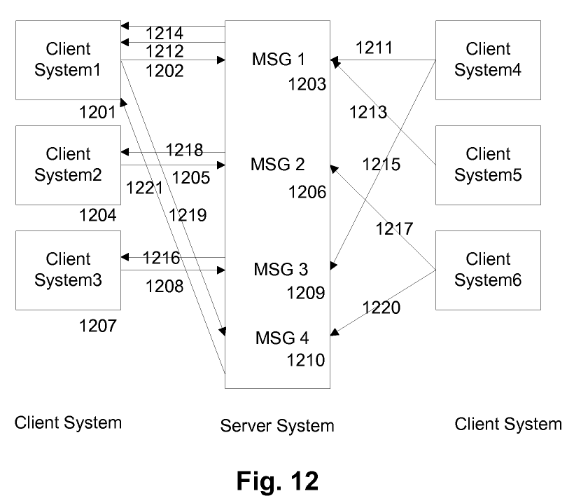

FIG. 12. shows a relationship table for one-to-many content posted on the web with replies coming back to the client system posting the content. Client system 1 posts two messages in the server system MSG1 1203 and MSG 4 1210, and gets reply back from Client system 4 1211, which the server systems sends the message back to the client system via 1212, and Client system 5 1213 responds to message 1, which the server system sends to the client system via 1214.

Client System 2 posts a message MSG2 1206, and gets a reply from client system 6 1217, which is delivered back to Client system 2 via 1218. Client system 3 posts a message MSG3 1209, and gets a reply from Client system 4, which the server system sends back to client system 3 via 1216. This relation shows in a one-to-many configuration, where the client posts a message to the server system to be accessed by other client systems: one client can post multiple messages, and on the reply side, one client system can respond to many messages, and the server system identifies the reply through message ID and reply ID, to send the message back.

The messages can be broken into 10 messages/page, with page one having the highest priority messages, followed by other messages in other pages. Each message is identified by its own messageID/UID with the date stamp. Other variations of these message arrangements/priority/listing are also obvious variations of our current teaching.

### Alternative Methods/Other Embodiments:

When the Server System assigns a New User ID for a message, users can request their own Alias.

The same method can be used for Voice/Video and picture Messages, instead of text messages.

This concept of private SMS can be enabled for web-based transactions for users to communicate securely and privately.

Initial messages can be sent to make the Caller ID visible by using the tag Privacy off, in the body of the message.

Messages could be automatically deleted after x days.

FIG. 5 shortcuts can be used: e.g. b for ban and r for reinstate, in the keyword of the messages. Any abbreviation, symbol, or shorthand, by any entity or organization, can be incorporated here, to shorten the length of messages.

Mobile user can communicate with other mobile users privately/securely.

### The Unique Features of the Invention/Different Embodiments:

1) One-to-many (mobile-to-mobile): a mobile user posts a content (voice/video/text) on to the website through SMS to the server system, which can be responded to by users through a client system (mobile phone), by accessing the posted content through WAP, WML, or XHTML. This solution enables users with just a mobile phone to engage in bi-directional communications with other client systems on their mobile or a computer. This bridges the digital divide—all the user needs is a mobile phone to communicate (conduct commerce) globally.
2) One-to-many (mobile-to-computer): a mobile user posts a content (voice/video/text) on to the website through SMS to a server system, which can be responded to by a clients system (computer) in the Internet by clicking on the MSG ID, which will open up a form. The user fills out the form which has two fields: one for their message and the other for their mobile number. Since this solution does not require any user registration, we need to verify the user's mobile number, so when others reply to this message, we know that we are sending the message to a valid device ID. When the user after filling in the phone number and message fields clicks on SEND to send the message from the web-based form, the gateway receives the message and sends a text message back to the users mobile posting the message, and waits for an Acknowledgement through a text reply back. If the message is received, the CPE processes the content, and goes through the Validation process (CPE), and the message is delivered or posted on the web. Otherwise, the message is dropped after predefined time interval.
3) One-to-One communication through Proxy (mobile-to-mobile): This is a direct peer-to-peer communication between mobile users using the server system to communicate privately, without disclosing their device ID. Traditional text (SMS) messages will reveal the users' mobile ID. No registration/password login, or computer is necessary to use this system. All the end-user needs is a mobile phone, and they communicate using the Server System to other mobile systems.

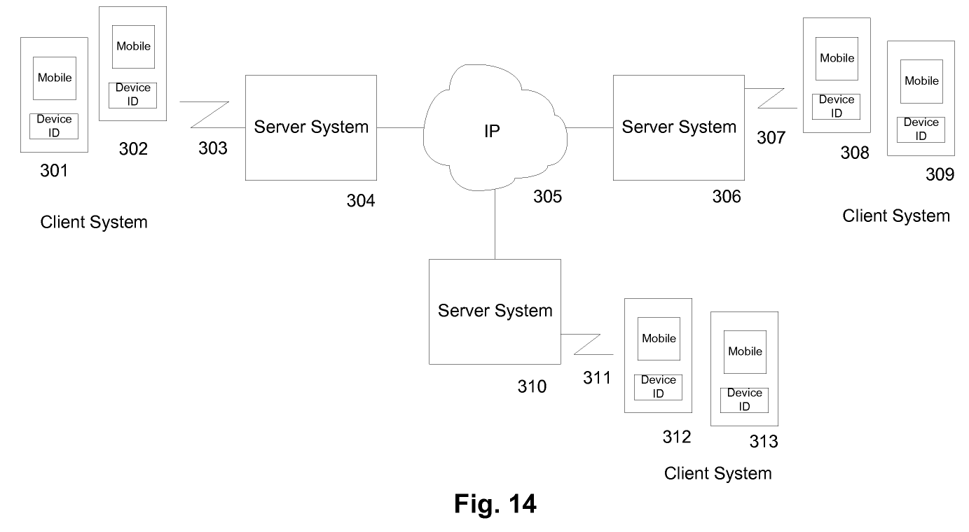

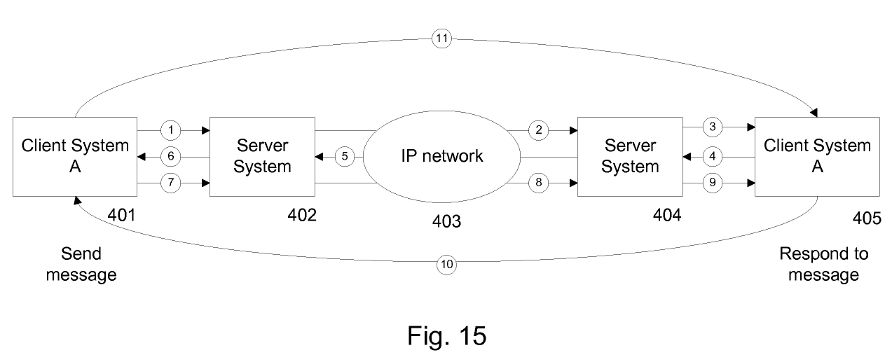

Note that 4 different situations are covered here, all of which enable text/sms/mms communication between users, either local or across countries bi-directionally, using a private alias-based system, using their mobile systems:
1) One-to-one (aka, peer-to-peer, mobile-to-mobile) using a single Server system (see FIGS. 9 and 10).
2) One-to-one (aka, peer-to-peer, mobile-to-mobile) using a distributed server systems (see FIGS. 14 and 15).
3) One-to-many (aka, mobile-to-web) using a single Server system.
4) One-to-many (aka, peer-to-peer, mobile-to-mobile) using a distributed Server systems.

Let's review FIGS. 9-10 again: FIG. 9 is a block diagram illustrating an embodiment of the present invention for mobile-to-mobile proxy communication (one-to-one). This embodiment supports direct bi-directional peer-to-peer communication between mobile phones, through the server system, by obfuscating the mobile ID of the client systems. The server system 901 comprises of a server engine 902, content DB (database) 903, a table for device ID/user ID mapping 904, a table for user ID/message ID mapping 907, a gateway 905, and a content processing engine 906.

Client system 900 sends a text message to client system 908 through the server system 901 using the client system 908 phone ID or its user ID. The server engine maps the device ID of the client systems 900 with a unique user ID, and sends the message to client system 908. Client system 908 replies back to the message, with optional privacy flag enabled or disabled, through the server system. The server system looks at the user ID/device ID table, and sends the message to client system 900. If the privacy option is enabled, the reply will have the user ID of the client system 908. Otherwise, the device ID of the client system 908 will be shown to client system 900.

FIG. 10 is a flow diagram illustrating an embodiment of the present invention for one-to-one communication using mobile-to-mobile client systems. Client system A 1001 sends a text message to client system B 1003 through the server system 1002, either by using client system 1003 user ID, alias, or its device ID.

In 1, the server system 1002 receives the message along with the device ID, message, time message received, flag options for privacy (on or off), and the user ID (or device ID) of client system 1003. After passing the validity check through the content processing engine, in the server system, the message is sent to (2) the client system B 1003. If privacy flag is enabled as requested by client system A 1001, client system B 1003 will receive the message with Client system A's 1001 user ID, or alias, if it had been set up.

Client system B 1003 replies (3) to A with a message with privacy on, through the server system 1002. The server system 1002 delivers the reply message back (4) to Client system A 1001, with the user ID, or an alias, if it had been set up.

Client system A 1001 replies back to the reply (5) with privacy off, through the server system 1002, to Client System B 1003. The server system 1002 delivers the message (6) this time to client system B 1003, with client system A's 1001 message and the phone ID, as the message was sent with privacy off.

Now that the Client system B 1003 knows the Client system A's phone number, communication can be done directly, bypassing the server system.

FIG. 14 is an illustration of a distributed model for mobile-to-mobile communication through a proxy system. This design incorporates multiple server systems in different countries to receive messages sent from the client systems in each of those countries, locally, and transport those messages through an IP network for inter-country text messages, thus, saving international toll charges for the text message communication between client systems located in different countries.

Client system 301 and 302 is local to Server system 304 (e.g. US). Client system 308/309 is local to Server system 306 (e.g. UK), and Client system 312/313 is local to Server system 310 (e.g. India). Text messages sent between Client system 301 and 302 works similar to what is described in FIG. 9, where the Server system 304 process the messages. In this illustration, Server system 304 has a country code of +1 (US), Server system 306 has a country code of +44 (UK), and the Server system 310 has a country code of +91 (India). If the Client system 301 located in the US wants to communicate to the Client system 308 in the UK, without this distributed architecture, the Server system 304 after receiving the message from 301 has to forward the message to the Client system 308 through international SMS, which can be expensive. With this distributed architecture, Server system 304 does a lookup on the alias that the Client system 301 wants to communicate, and determines that the home location for the alias is mapped to a device ID served by Server system 306. Server system 304 receives the message from the Client system 301, does content validation through the Content Processing Engine in 304, and if the message passes the content validation process, it is then forwarded to the Server system 306 through an IP network 305. Once the message is received by 306, it is then forwarded to 308.

Client system 308, while replying back anonymously to 301, will just reply back to the alias of 301, and send it to the appropriate Server systems 306 gateway number or Common Short Code. The Server system 306 receives the message, does an alias lookup to determine the Server system it needs to send this reply to, processes it by validating against the content processing engine, and if the validation is successful, the message is then forwarded to Server system 304 via the IP network 305. The Server system 304 does a lookup on the alias and sends the message to Client system 301.

At any given moment, all the alias device mapping information across all the distributed Server systems are synchronized, so that every Server system knows the home location Server associated to a specific alias. This synchronization is done either through a triggered update or a timed interval update. The IP network 305 can be a private/public network. These distributed Server systems enable private text/sms communication between client systems bypassing expensive international SMS charges.

FIG. 15 is a flow diagram illustrating an embodiment of the present invention for one-to-one communication using mobile-to-mobile client systems in a distributed model. Client system A 401 sends a text message to Client system B 405 through the Server system A 402's CSC or the number associated with the GSM interface, either by using client system B 405 user ID, alias, or its device ID. Client System A's 401 home location is Server System A 402.

In (1), the Server system 402 receives the message along with the device ID, message, time message received, flag options for privacy (on or off), and the user ID (or device ID) of client system 405. After passing the validity checks through the content processing engine, in the server system, a lookup is done on the Client system B's 405 User id/Alias, if the device ID is not included in the Send To of the message by the Server system 402. Once after the lookup is done, the Server system 402 determines the home location for the Client system 405 with Server system 404, and forwards the message (2) through an IP network. The Server system 404 does a lookup on the UserID or Alias to get the device id for Client system B 405, and forwards the message (3). If privacy flag is enabled by client system A 401, client system B 405 will receive the message with Client system A's 401 user ID, or alias, if it had been set up.

Client system B 405 replies (4) to A with a message, with privacy on, through the server system 404's CSC or the number for the GSM interface. The server system 404 does a lookup on the alias/userid, and determines the home location for the alias and sends the reply back (5) to Server system 402 through an IP network 403. The Server system 402 does a lookup for the alias or userid, and sends the message (6) to Client system A 401, with the user ID, or an alias (if it had been set up) of Client system B 405. The UserID and the alias are unique across all the Server systems and are mapped to a device id.

Client system A 401 replies back (7) to the reply (6), with privacy off flag, through the server system 402, to Client System B 405. The server system 402 does an alias/userid lookup and delivers the message (8) to Server system B 404 through the IP network 403, which then sends the message (9) to client system B 405, with client system A's 401 message and the phone ID, as the message was sent with privacy off.

Now that the Client system B 405 knows the Client system A's 401 phone number, communication can be done directly (10), (11), bypassing the server system.

This distributed architecture can also be extended to the one-to-many implementation, where a Client system posts a message to a Server system, the Server system after successful content validation, stores the message in a content database along with the date, time, device ID, alias, send to alias, etc. In this implementation, one of the Server system acts as a master aggregator, where all the contents from other Server systems are constantly updated and synchronized. The user ID aliases and the device ID's are synchronized across all the Server systems, both the master and backup. The content in the master Server system is then rendered into various formats, such as xml, wml, xhtml, etc. (for web browsers and PDAs to access).

Note that one server acts as an aggregator or master, and the rest act as slave.

The content can be accessed by users using html, wml, xml, xhtml mp, etc., from anywhere, and can respond to a specific message by using the alias/message ID contained in each of the messages through the local Server system that the Client system belongs to. The local Server system does an alias to device id lookup to determine the home location of the alias of the Client system, and forwards the message to the appropriate Server system through an IP network. The Server system then forwards the message to the Client system, using SMS.

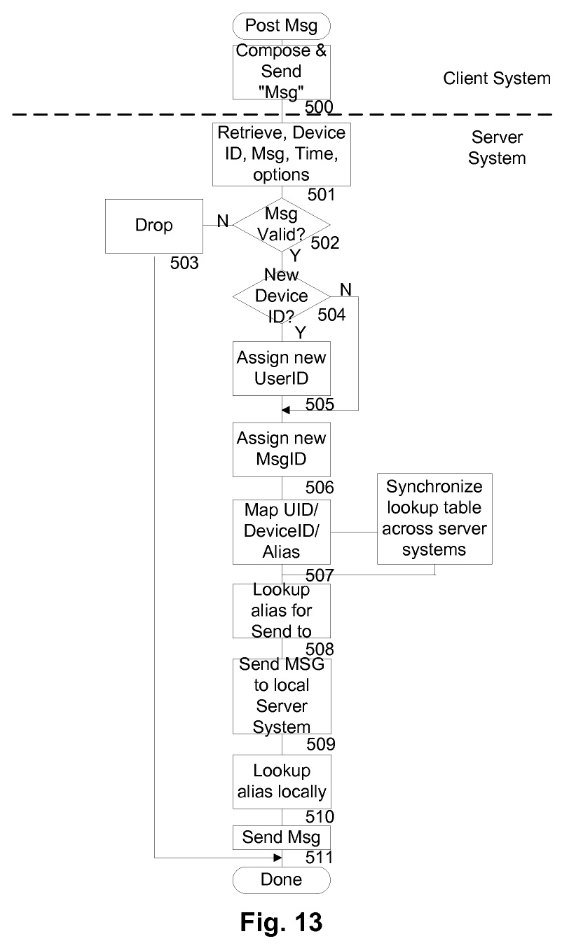

In the distributed architecture (for peer-to-peer), the message is forwarded to the Server system that is closest to the home location of the Client system. The user id, alias, and device id are constantly synchronized across the different Server systems. At any given time, the Server systems know where a specific user alias is located and served by which Server system, based on their device ID. For example, +1, +44, and +91 indicate that the Server systems for each of the those device id beginning with those numbers are based in US, UK and IN, respectively. (The details are given in FIG. 13.)

In both one-to-one through proxy or one-to-many implementations, the userid, device id, and alias mapping table are replicated across the Server systems. The messages are stored in the originating Server systems (one-to-one), and then forwarded to the Client systems. In one-to-many implementation, the messages received by each of the Server system are aggregated at a central database along with associations to the message owners device id, alias, etc.

Note: To combine two systems, one can combine two databases, and cross-license between the owners of two databases.

4) Content Processing Engine is the brain behind the server system, and it does the following:

Checks for format validation of the content (otherwise, discards it).

Checks content for spam against known spammers, content from the Server System DB.

Checks content for spam against known spammers, through device ID from the Server System DB.

Checks for transaction rate limiting, e.g. “x” number of messages in “n” minutes.

Checks for incoming messages and process requests (edit, delete, get, pause), based on Keywords during one-to-many communications (e.g. Msg posted on the web).

Checks for incoming messages and process requests (ban, alias, profile, get), based on Keywords during one-to-one (peer-to-peer) communications through proxy.

Checks for shortcuts in the incoming messages and process requests (e.g. b for ban, e for edit, d for delete, p for pause, a for alias, and etc.).

Checks for incoming messages and can ban user administratively.

Checks for incoming messages and can transaction rate limit, through a hold down timer for x hours: during this x hours all messages from the user will be ignored.

Maintains transaction logs, purges, or sets “x” message before hold down, to restrict communication between two client systems, in peer-to-peer using mobile proxy.

Administrator can clear the hold down ban, adjust metrics in transaction rate limiting, transaction logs, and etc.

Limit trial users for x messages/day, paid users e.g. 200 messages/month, and etc.

Contents are assigned a Dynamic list priority (a number) based on different metrics (as described earlier). Best relevant content gets more visibility and appears on the top of the website.

### 5) Dynamic List Priority

The client system sends the message via SMS and is received by the server system. The server system assigns a unique identifier to this message, and associates the UID to the 10-digit phone number of the client system. A priority number is associated to this message ID, based on various metrics, such as the keywords in the item title and item description, location of the listing, category of the listing, external web links associated to the message, age of the message, pictures associated with the message, if it's a paid message, user rating, number of characters in a message, and the number of responses received for this message. Each of these messages has user ratings, that others rate based on responsiveness of the listing agent, which will be included in calculating the priority number.

The priority number determines the ranking of various message ID's. A higher message priority number signifies a message that is well-written and complete, as opposed to one with a lower priority number. The priority number changes constantly based on dynamic variables, such as age of the message, user rating, and response received for the message. The dynamic algorithm with variable parameters is necessary to avoid hackers abuse the rating system.

The abbreviations are recognized by the (smart) system here. For example, “house 4 sale” will be expanded as “house for sale” (to sell a house).

Lower points or weights are given for older messages. Repeat messages in a short period of time is either eliminated or given a low point or score.

### Algorithm for Assignment of Points:

### Metrics: List of Parameters:

### M1=number of keywords

### M2=any phone numbers

### M3=any weblinks, and its quality/quantity

### M4=pictures, audio, video (content: quality/quantity)

### M5=premium paid messages (e.g. a paid user)

### M6=category (e.g. selling a car)

### M7=location of the user

### M8=user rating, by others

### M9=analytics, (e.g. web logs, where users coming from, and location of key customers)

### M10=age of the message

### M11=number of replies

### M12=number of characters in a message

. . .

### Mn (other parameters)

### In General, We Assign Different Weights (Wn) to All Parameters, to Find the Ranking:

Message ranking priority=[(M1*W1)+(M2*W2)+(M3*W3)+ . . . +(Mn*Wn)]/[W1+W2+ . . . +Wn]

### Using Dynamic Weights, D:

The dynamic weights, Dn, will replace Wn in the formula above, to make it harder for hackers to detect the pattern of weight assignment, to make it harder to abuse the message ranking system.

Note that in the formula above, we can normalize the numbers, by dividing the values by n. Or alternatively, we can compare it to (divide it by) a base value, normalized as 100 percent (or 1).

Examples for subject may include: sale of car, sale of house, incomprehensible or unacceptable text, emergency help request, and sale of car in Chicago. The priority score for incomprehensible or unacceptable text is very low, and the priority message score is very high for emergency SOS/help request. If we are searching for cars in Chicago, the message with the majority of the keywords described above gets higher score than the ones with the content with the least number of matrix as defined above. The scores and weights are adjusted periodically to reflect different situations and change of settings.

One can use different weighting formulas, such as non-linear weights or coefficients. In general, the larger the number of parameters, the harder for the hackers to guess the formula, and thus, the longer period of time required for change of coefficients. Therefore, one can say the following:

Assuming:

N=number of parameters

T=minimum period of time, needed to change the coefficients

(K=a proportionality factor)

Then:

T=K*N

(i.e T is proportional to N)

The listings can be re-arranged per day, per hour, per week, etc. The search can be done based on keywords, such as selling cars in Baltimore on Jun. 15, 2006. If the price is listed, the weight factor goes up. If it is more recent, the weight factor goes up (top of the list, with the highest priority). The user can search for a price range. The user can link the searches and categories. In one embodiment, the top 10 listings of cars, real estate, etc. are shown on the client's system. Other factors for weight assignment are user rating and responsiveness, and premium users (paid listings). The combination of mobile postings and computer postings are considered.

List priority is a part of content processing engine, and can be used for any search engine.

The content of the original message or any subsequent message between any parties can be one or more of, or combination of, text, voice, music, sound, multimedia, video, images, tables, forms, and databases. The subject of the messages can be any of these (as examples): general messages, advertisements, sales, auctions, or emergency SOS/help requests, and the messages can be categorized.

The disclosure above is intended as an example and embodiment. Thus, any variations of the current teaching are also intended to be included for our patent protection.

What I claim as my invention is:

1. A system for one-to-one communication through proxy, said system comprises:
a network of devices,
wherein said network comprises two or more devices,
wherein said network comprises a proxy unit, and
wherein said two or more devices communicate with each other through said proxy unit.

2. A system as recited in claim 1, wherein said system is used in a telecommunication system.

3. A system as recited in claim 1, wherein said system is used in a commercial or transactional setting.

4. A system as recited in claim 1, wherein said system comprises a single server.

5. A system as recited in claim 1, wherein said system comprises a distributed server system.

6. A system as recited in claim 1, wherein said system uses SMS for communication.

7. A system as recited in claim 1, wherein said system uses user's mobile ID.

8. A system as recited in claim 7, wherein said system maps said user's mobile ID.

9. A system as recited in claim 1, wherein said system uses system-assigned user ID.

10. A system as recited in claim 1, wherein said system uses user's alias.

11. A system as recited in claim 1, wherein said system further comprises the option to turn off or turn on the privacy feature.

12. A system as recited in claim 1, wherein said system further comprises a validity check module.

13. A system as recited in claim 5, wherein said distributed server system is located across multiple countries.

14. A system as recited in claim 5, wherein one of the servers in said distributed server system is an aggregator.

15. A system as recited in claim 13, wherein the client systems are located in different countries, wherein said client systems communicate through local server systems, and the SMS messages are transported between said server systems via IP networks.

16. A system as recited in claim 1, wherein said system further comprises a content database.

17. A system as recited in claim 1, wherein said system further comprises an IP network.

18. A system as recited in claim 10, wherein said system further comprises a module that determines the home location for said user's alias.

19. An apparatus for one-to-one communication through proxy,
wherein said apparatus is connected to a network,
wherein said network comprises one or more devices, and
wherein said apparatus interacts with said one or more devices in said network through a proxy unit.

20. A method for one-to-one communication through proxy, said method comprises the steps of:
connecting a first device to a network;
connecting a second device to said network;
connecting a proxy unit to said network; and
connecting said first device to said second device through said proxy unit.
